(19) United States
(12) Patent Application Publication
(10) Pub. No.: US 2020/0003557 A1
(43) Pub. Date: Jan. 2, 2020

(54) ROAD GRADE MEASUREMENT SYSTEM FOR MOVING VEHICLES

(71) Applicants: John GAZZA, Farmingdale, NY (US); David R. MUNRO, St. Petersburg, FL (US); Stephen B. CONRAD, Howell, MI (US)

(72) Inventors: John GAZZA, Farmingdale, NY (US); David R. MUNRO, St. Petersburg, FL (US); Stephen B. CONRAD, Howell, MI (US)

(21) Appl. No.: 16/480,789

(22) PCT Filed: Jan. 24, 2018
(86) PCT No.: PCT/US2018/015029

§ 371 Date: Jul. 25, 2019

Related U.S. Application Data
(60) Provisional application No. 62/450,289, filed on Jan. 25, 2017.

(51) Int. Cl. G01C 9/06; G01C 21/32

(52) U.S. Cl. CPC G01C 9/06; G01C 21/32

(57) ABSTRACT

A system for measuring a grade of a road includes at least two ride height sensors. Each sensor is mounted to the vehicle to detect a distance between the road and Its mounting location. Acceleration sensors mounted to the vehicle detect acceleration of the vehicle along at least one axis. Gyroscopes mounted to the vehicle detect one of pitch, roil or yaw of the vehicle. A global positioning unit (GPU) determines a geolocation of the vehicle. A processor includes at least one input connected to the height sensors, at least one input connected to the acceleration sensors, at least one input connected to the gyroscopes, and at least one input connected to the GPU. The processor is configured to calculate road grade from the plurality of Inputs and to associate the calculated road grade with geolocation of the vehicle associated with the calculated road grade.

### CROSS REFERENCE TO RELATED APPLICATION

This International PCT patent application is related to, and claims the benefit of priority of U.S. Provisional Patent Application No. 62/450,289, entitled ROAD GRADE MEASUREMENT SYSTEM FOR MOVING VEHICLES, filed Jan. 25, 2017, the contents of which are incorporated herein by reference herein in its entirety for all purposes.

### FIELD OF THE INVENTION

The present invention relates, generally, to the field of vehicle dynamic and orientation measuring systems and improvements in the understanding of continually changing vehicle dynamics and orientation, as it is in motion, and how it effects driver behavior, combustion engine performance, fuel efficiency, vehicle emissions, and other vehicle related outputs not included in this initial description.

### BACKGROUND OF THE INVENTION

Due to the need for regulatory requirement for real driving emission testing in the US and Europe, car manufacturers (OEMS's) need to test their vehicles under real world condition and then replicate the route travelled by a vehicle in the lab. To accurately replicate the route travelled by a vehicle in the lab it is necessary to account for road grade. Road grade affects vehicle performance and the impact on performance cannot be calculated without knowing the precise grade of the road. Without a device that can accurately measure grade consistently, the OEM's may have difficulty meeting the accuracy desired to understand performance or to meet regulations.

There is also a growing need amongst sports enthusiast, runners and cyclist to know road grades so that they can plan routes, although GPS gives an indication, the indication is not accurate and does not account for bridges, tunnels and underpasses. GPS altitude does not have sufficient accuracy for the purposes discussed herein, although some GPS devices may include a barometric altimeter for altitude correction, and still others may use GPS coordinates cross-referenced with existing elevation data, such as compiled by the USGS digital elevation map (collected from LIDAR measurements by airplanes). Even so, real-time calculation of road grade from altitude data has limitations, as compared to the methods described herein, which enable compilation of a database of pre-established and accurately measured road grade values referenced to GPS coordinates. Accurate road grade measurements can also be used by a drive or GPS system to account for road grade in the interest of improving fuel efficiency.

### SUMMARY OF THE INVENTION

One aspect of the invention comprises a system for measuring a grade of a road, the system comprising at least two ride height sensors configured for mounting to a vehicle, one or more acceleration sensors configured for mounting to the vehicle, one or more gyroscopes configured for mounting to the vehicle, a global positioning unit configured for mounting to the vehicle and for determining a geolocation of the vehicle, a processor, and a computer memory. Each sensor is configured to detect a distance between the road and the mounting location on the vehicle. Each acceleration sensor is configured to detect acceleration of the vehicle along at least one axis, and each gyroscope is configured to detect one of pitch, roll or yaw of the vehicle. The process has a plurality of inputs, including at least one input connected to a data output from each of the at least two ride height sensors, at least one input connected to the one or more acceleration sensors, at least one input connected to the one or more gyroscopes, and at least one input connected to the global positioning unit. The processor is configured to calculate road grade from the plurality of inputs and to associate the calculated road grade with geolocation of the vehicle associated with the calculated road grade. The computer memory is connected to the processor and configured to receive and store the calculated road grade and associated geolocation in a computer readable memory for a plurality of geolocations along a path of the vehicle.

In one embodiment, one ride height sensor is located relatively closer to a front of the vehicle and another ride height sensor is located relatively closer to a rear of the vehicle. Each of the ride height sensors may be positioned on a centerline of the vehicle on a longitudinal plane parallel to the road. A first acceleration sensor may be configured to measure acceleration in an X direction, a second acceleration sensor in a Y direction perpendicular to the X direction, and a third acceleration sensor in a Z direction perpendicular to the X and the Y directions. A first gyroscope may be configured to detect pitch of the vehicle, a second gyroscope may be configured to detect roll of the vehicle, and a third gyroscope may be configured to detect yaw of the vehicle. The one or more acceleration sensors and the one or more gyroscopes may be integrated into an inertial measuring unit. The processor may be configured to calculate the road grade in real time. A data collection connected to the ride height sensors, acceleration sensors, gyroscopes, and global positioning unit may be configured to collect data comprising one or more of: time, velocity, heading, height, vertical velocity, lateral acceleration, longitudinal acceleration, radius of turn, pitch angle, roll angle, and yaw angle.

Another aspect of the invention comprises a vehicle comprising the system as described herein. Yet another aspect of the invention comprises a method for measuring a grade of a road, comprising the steps of providing such a vehicle and moving the vehicle over a path and calculating, storing, and associating the plurality of road grades with the geolocations along the path.

Still another aspect of the invention comprises a method for providing navigational information for a vehicle, the method comprising measuring the grade of a road associated with geolocations of the road in using a vehicle in accordance with the method for measuring the grade of a road as discussed herein, and associating the grade of the road with other road information corresponding to the same geolocations and storing the associations in a navigational database. This method may further comprise providing the grade of the road to a user of the navigational database, such as, for example, a user of a vehicle on-board GPS system, or a user of a portable GPS system (such as a bicyclist, runner, walker, or the like).

Another aspect of the invention comprises a method for testing a vehicle, the method comprising providing a vehicle to be tested, providing a dynamometer configured to receive the vehicle to be tested, selecting a virtual path for testing of the vehicle by simulated driving of the vehicle along the virtual path, providing navigational information corresponding to the virtual path, and moving the dynamometer in accordance with the road grade information in the navigational database during the simulated driving of the vehicle, wherein the navigational information comprises road grade information associated with geolocations along the virtual path. The road grade information associated with the geolocations is preferably provided in accordance with the methods as described herein.

Still another aspect of the invention comprises a navigational device comprising an input for receiving a geolocation command and a processor in communication with a computer memory having stored navigational information corresponding to geolocation information, the processor configured to retrieve the stored navigational information from a database including road grade information stored in the database. The navigational device may further comprise an output configured to display the road grade information. The processor may be further configured to recommend a path between two or more geolocation points entered by a user in accordance with recommendation criteria, wherein the recommendation criteria includes said road grade information. The input for receiving the geolocation command may include a receiver configured to receive geolocation information corresponding to a position of the device. The input for receiving the geolocation command may include a user input for specifying the at least two geolocation points. A computer memory may be integrated into the device. One embodiment may comprise a transceiver configured to transmit and receive information from a global computer information network, wherein the computer memory is connected to the global computer information network and not integrated into the device.

Another aspect of the invention comprises a system for testing a vehicle, the system comprising a dynamometer configured to receive the vehicle to be tested, a user input for selecting a virtual path for testing the vehicle by simulated driving of the vehicle along the virtual path, and a processor configured to access navigational information comprising road grade information associated with geolocations along a physical path corresponding to the virtual path and to move the dynamometer in accordance with the road grade information during the simulated driving of the vehicle along the virtual path.

### BRIEF DESCRIPTION OF THE DRAWINGS FIGURES

FIG. 1A depicts a top plan view of a vehicle, shown schematically.

FIG. 1B depicts a side elevation view of the vehicle.

FIG. 2A depicts a schematic view of acceleration of the vehicle, shown schematically, on a flat grade.

FIG. 28 depicts a schematic view of deceleration of the vehicle on a flat grade.

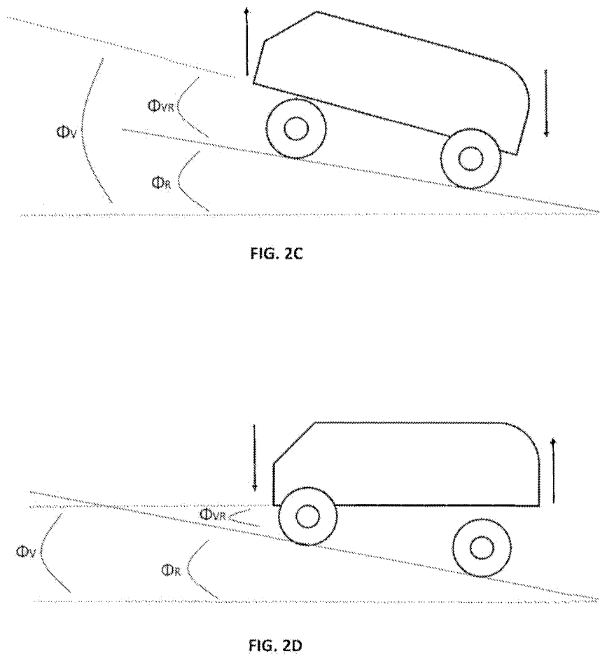

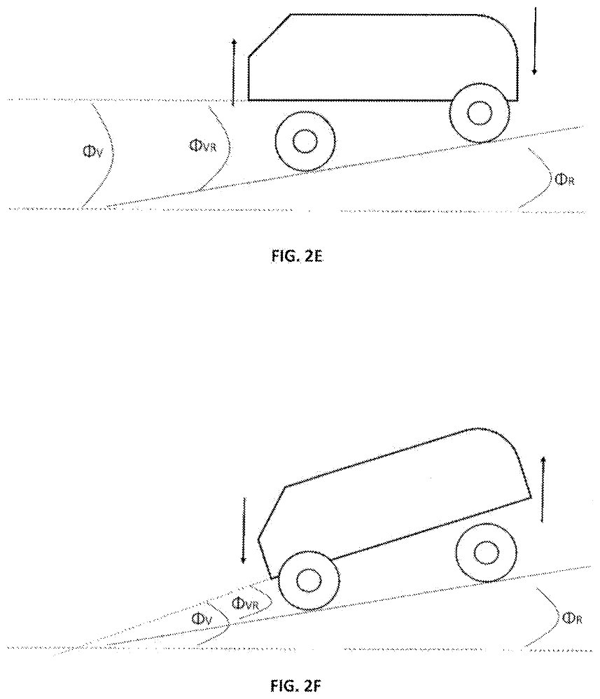

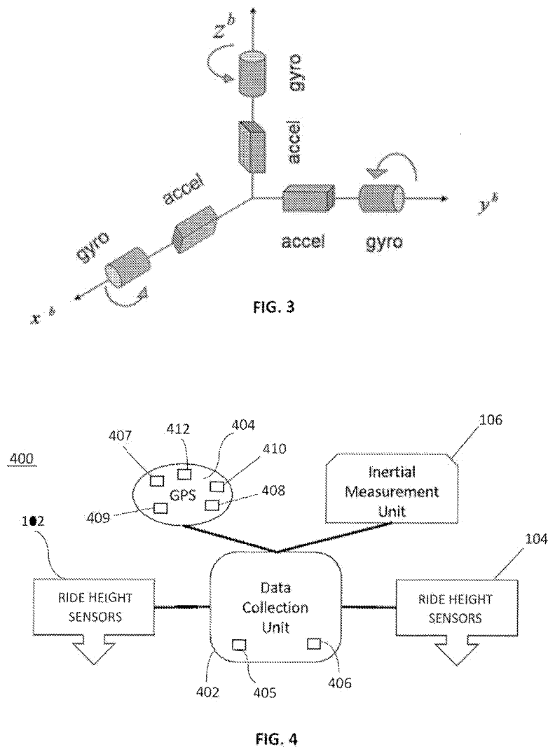

FIG. 2C depicts a schematic view of acceleration of the vehicle on a grade incline.

FIG. 2D depicts a schematic view of deceleration of the vehicle on a grade incline.

FIG. 2E depicts a schematic view of acceleration of the vehicle on a grade decline.

FIG. 2F depicts a schematic view of deceleration of the vehicle on a grade decline.

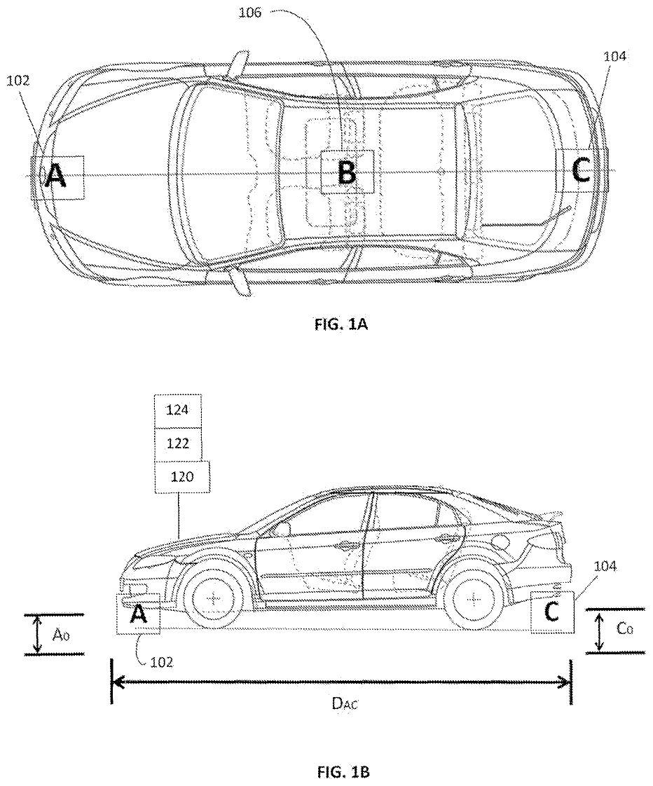

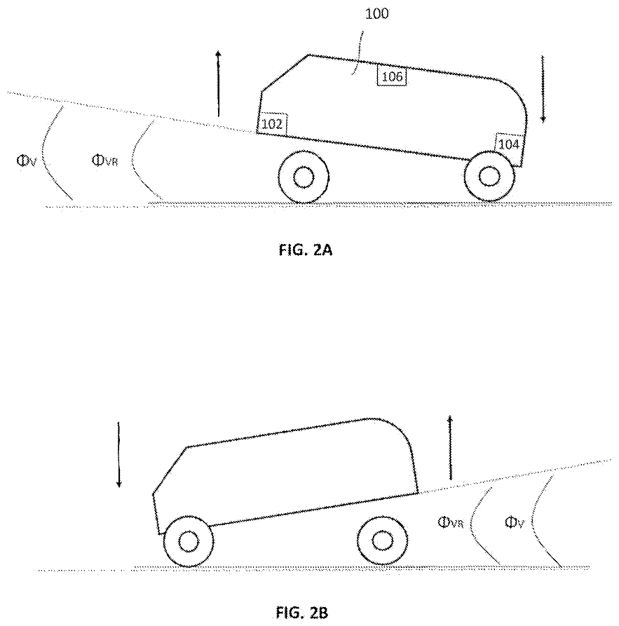

FIG. 3 is a schematic showing an exemplary inertial measurement unit (IMU) for the vehicle of FIGS. 1A and 18.

FIG. 4 depicts a system for calculating a grade of a road upon which the vehicle of FIGS. 1A and 18 travels.

### DETAILED DESCRIPTION OF THE INVENTION

FIGS. 1A and 18 depict a schematic view of a vehicle 100 having ride height sensors 102 and 104 and an inertial measurement unit (IMU) 106. The ride height sensors 102 and 104 are positioned along the longitudinal center line CL of the vehicle 100 at locations A and C, i.e., at the front and rear of a vehicle 100, respectively. The IMU 106 is positioned at the top of the vehicle and along the center line CL of the vehicle 100 at location B.

The ride height sensors 102 and 104 are utilized to measure the distance between the frame of the vehicle 100 and the underlying road. Ride height sensors 102 and 104 are known in the art and commercially available.

It should be understood that the type of ride height sensor can vary from that which is shown and described. Ride height sensors can be embodied by laser sensors, LED sensors, ultrasonic sensors, eddy current sensors, contact sensors, and any other sensors that can be considered in the ride height sensor family (e.g. suitable for measuring distances in the range of typical vehicle ride height). According to one example of a ride height sensor, a visible red laser of the sensor is focused onto the road beneath the vehicle 100. Reflected light is collimated onto a linear CCD array of the sensor. The distance between the mount for the laser and the road is calculated based upon the position of the light spot of the CCD array. The output of the sensor is directly proportional to the measured ride height.

The IMU 106 comprises one or more accelerometers and gyroscopes. Location B is at the top of the vehicle 100 and centered along the longitudinal axis CL. Location B is a general placement, intended to give the best possible location for readings for the accelerometers and gyroscopes of the IMU 106.

FIG. 3 shows the IMU 106 for the vehicle 100. The accelerometers of the IMU 106 are configured to measure the vibration and acceleration of the vehicle about the axes x, y and z. The preferred embodiment of the IMU 106 will include three (3) accelerometers (i.e., one per axis). The type of accelerometers to be used shall include, but not be limited to, premium grade, industrial grade, high vibration, and triaxial accelerometers or high or low impedance. The gyroscopes of the IMU 106 are configured to measure the pitch, roll, and yaw rate of the vehicle. The preferred embodiment of the IMU 106 includes three (3) gyroscopes (i.e., one per axis).

The vehicle 100 also comprises a Global Positioning System (GPS) 404 for determining a geolocation of the vehicle among other information relating to the vehicle. Global positioning may be integrated with inertial measurement via GPS. GPS allows specific geolocation of vehicle, and its related combustion engine, providing necessary information for accurate calculations of road grade and road grade changes in real world driving conditions. Integration with engine information and parameters, such as data collected from a vehicle ECU, including but not limited to vehicle power, may also be included in a “sensor fusion” approach.

The GPS 404 includes an input 407 for receiving a geolocation command. The input 407 for receiving the geolocation command comprises a receiver configured to receive geolocation information corresponding to a position of the device. The input 407 for receiving the geolocation command includes a user input for specifying at least two geolocation points. The GPS 404 also includes a processor 408 in communication with a computer memory 409 having stored navigational information corresponding to geolocation information. The computer memory 409 may be integrated with the GPS 404 or another device (as is described later). The processor 408 is configured to retrieve the stored navigational information from a database including road grade information stored in the database. The processor 408 is further configured to recommend a path between two or more geolocation points entered by a user in accordance with recommendation criteria, wherein the recommendation criteria includes the road grade information. An output 410 of the GPS may be configured to display the road grade information to a user.

The GPS 404 may include a transceiver 412 that is configured to transmit and receive information from a global computer information network. If the computer memory 409 is not integrated into the GPS 404, the computer memory 409 may be connected to the global computer information network.

FIG. 4 depicts a system 400 for calculating a grade of a road upon which the vehicle 100 of FIGS. 1A and 1B travels. The system 400 may be incorporated directly into the vehicle 100. The system 400 generally includes a data collection unit (DCU) 402 in the form of a digital computer having a memory 405 and a processor 406. The processor 406 is configured to receive and process data from the above-described IMU 106, GPS 404, and ride height sensors 102 and 104. The DCU 402 may be a digital computer having a computer memory 405 and the processor 406. The processor 406 is configured to calculate the road grade based upon the data received from the IMU 106, GPS 404, and ride height sensors 102 and 104, as is described later. The calculated road grade may be stored in the memory of the DCU 402 or another device.

Utilizing the DCU 402, the preferred embodiment will be able to include, but not be limited to, data such as time (which may be gathered from GPS information and/or an internal or external reference clock), vehicle position, vehicle velocity (such as calculated via GPS 404), vehicle heading (such as provided by GPS information, which may be supplemented by IMU 106 (magnetometer) data), ride height (as measured by the road height sensors 102 and 104, but GPS altitude information may also be taken into account), vehicle vertical velocity (such as may be measured by GPS Information), vehicle lateral acceleration (such as measured by the accelerometers and/or gyroscopes of the IMU 106), vehicle longitudinal acceleration (as derived from vehicle speed and yaw rate as measured by gyroscopes of the IMU 106), vehicle turn radius, and pitch, roll, and yaw angles (such as measured by gyroscopes and from filtered values using both GPS and IMU data).

Data can be collected in the preferred embodiment including, but not limited to, Serial, Analog, Wi-Fi, Bluetooth, USB, Compact Flash Card functionality. Data may be primarily stored locally in the memory 405 of the DCU 402 located in the vehicle. Data may be transferred to other storage locations, however, such as by direct physical (e.g. flash drive) or remote (e.g. wireless) methods, including over a cellular network. Accordingly, data may ultimately be stored long term “In the cloud.” Various data collection and storage methods may be used for collecting and uploading data to minimize local data storage (such as by uploading to the cloud periodically), to minimize cellular data charges (such as by providing larger physical storage and methods for uploading data only when in range of Wi-Fi, for example), or to minimize loss of data (such as by periodically uploading data to the cloud, but also having large enough data storage to facilitate storage for long periods of time in areas of low signal strength and to upload quickly during periods of high signal strength). The invention is not limited to any particular method of data storage and collection.

The processor 406 of the system 400 is connected to the DCU 402 for receiving data therefrom. As shown in FIG. 4, the DCU 402 receives data from IMU 106, GPS 404, and ride height sensors 102 and 104; and, that data is passed along to the processor 406. Based upon the data received from the DCU 402, the processor 406 is configured to calculate road grade, as will be described hereinafter.

The equations provided hereinafter Illustrate how to calculate the road grade OR based upon the measurements of ride height distance data measured by the ride height sensors 102 and 104, which data is cross referenced with data from the IMU 106 and the GPS 404.

More particularly, the processor 406 solves for the equation: ϕ_{R}=ϕ_{V}−ϕ_{VR}, where
ϕ_{R} is the Road Angle (otherwise referred to as the road grade)
ϕ_{V} is the Vehicle Angle (relative to gravity). This quantity is measured with either three gyroscopes or three accelerometers.
ϕ_{VR} is the Vehicle to Road Angle. This quantity is the angle of the vehicle relative to the road. This quantity can be measured with the ride height sensors 102 and 104.

ϕ_{VR} can be calculated by the general equation: ϕ_{VR}=arc tan (Height Difference/Longitudinal Mounting Distance). More particularly, ϕ_{VR} can be calculated by the detailed equation:

$${Φ}_{VR} = arctan ( \frac{( A - {A}_{D} ) - ( C - {C}_{D} )}{{D}_{AC}} ) ,$$

where
A=Distance from sensor 102 to road,
A₀=Distance from sensor 102 to road on level road,
C=Distance from sensor 104 to road,
C₀=Distance from sensor 104 to road on level road, and
D_{AC}=Distance from sensor 102 to sensor 104.

The location of variables A₀, C₀, and D_{AC} are shown in FIG. 1B. A₀, C₀, and D_{AC} are fixed, known, quantities predetermined by the vehicle OEM at the factory that do not change depending upon operation of the vehicle 100. In contrast, distance A and distance C change dynamically during operation of the vehicle 100 and are measured by sensors 102 and 104, respectively.

The vehicle to road angle, ϕ_{VR}, is dynamically calculated by the processor 406 using the equation above. The vehicle to road angle, ϕ_{VR}, is then subtracted from the vehicle angle relative to gravity, ϕ_{V}. As noted above, the vehicle angle relative to gravity, ϕ_{V}, is measured with either three gyroscopes or three accelerometers and calculated by the processor 406. The processor 406 then subtracts ϕ_{VR} from ϕ_{V} to arrive at the road angle, ϕ_{R}, at any dynamic moment during operation of the vehicle 100.

FIGS. 2A-2F depict exemplary schematic views of a vehicle undergoing various maneuvers. For each of the vehicle maneuvers shown in FIGS. 2A-2F, (i) the vehicle to road angle, ϕ_{VR}, is dynamically calculated by the processor 406 using the equation above; (ii) the vehicle angle relative to gravity, ϕ_{V}, is measured with either three gyroscopes or three accelerometers and calculated by the processor 406; and (iii) the road angle ϕ_{R} is computed by the processor 406.

FIG. 2A depicts a schematic view of acceleration of a vehicle on a flat grade. In accordance with the exemplary equations shown below for discounting acceleration from the road angle ϕ_{R}, the calculated quantity ϕ_{VR} increases by 3 percent, for example, as the vehicle rocks backward relative to the ground. Rocking of the vehicle 100 is depicted by the vertical arrows. The measured quantity ϕ_{V} is increased by the same amount (e.g., 3 percent, for example) during acceleration. ϕ_{R}, the calculated road angle, is equal to zero according to the above equation, thereby indicating a flat grade.
ϕ_{VR}=+3%
ϕ_{V}=+3%
ϕ_{R}=ϕ_{V}−ϕ_{VR}=+3%−(+3%)=0%

FIG. 2B depicts a schematic view of deceleration of a vehicle on a flat grade. In accordance with the exemplary equations shown below for discounting deceleration from the road angle ϕ_{R}, the calculated quantity ϕ_{VR} decreases by 3 percent, for example, as the vehicle rocks forward relative to the ground. The measured quantity ϕ_{V} is decreased by the same amount (e.g., −3 percent, for example) during deceleration. ϕ_{R}, the calculated road angle, is equal to zero according to the above equation, thereby indicating a flat grade. It is noted that ϕ_{R}, the calculated road angle, shown in FIG. 2B is equal to that of FIG. 2A regardless of the maneuvers of the vehicle.
ϕ_{VR}=−3%
ϕ_{V}=−3%
ϕ_{R}=ϕ_{V}−ϕ_{VR}=−3%−(−3%)=0%

FIG. 2C depicts a schematic view of acceleration of a vehicle on a grade incline. In accordance with the exemplary equations shown below for discounting acceleration from the road angle ϕ_{R}, the calculated quantity ϕ_{VR} increases by 3 percent, for example, as the vehicle rocks backward relative to the ground. The measured quantity ϕ_{V} is increased by a greater amount (e.g., 6 percent, for example) during acceleration. ϕ_{R}, the calculated road angle, is equal to about 3 percent according to the above equation, thereby indicating a grade incline.
ϕ_{VR}=+3%
ϕ_{VR}=+6%
ϕ_{R}=ϕ_{V}−ϕ_{VR}=+6%−(+3%)=+3%

FIG. 2D depicts a schematic view of deceleration of a vehicle on a grade incline. In accordance with the exemplary equations shown below for discounting deceleration from the road angle ϕ_{R}, the calculated quantity ϕ_{VR} decreases by 3 percent, for example, as the vehicle rocks forward relative to the ground. The measured quantity ϕ_{V} is equal to 0 percent relative to gravity because the forwards rocking movement of the vehicle offsets the effect of the grade incline during deceleration. ϕ_{R}, the calculated road angle, is equal to about 3 percent according to the above equation, thereby indicating a grade incline. It is noted that ϕ_{R}, the calculated road angle, shown in FIG. 2D is equal to that of FIG. 2C regardless of the maneuvers of the vehicle.
ϕ_{VR}=−3%
ϕ_{V}=0%
ϕ_{R}=ϕ_{V}−ϕ_{VR}=0%−(−3%)=+3%

FIG. 2E depicts a schematic view of acceleration of a vehicle on a grade decline. In accordance with the exemplary equations shown below for discounting acceleration from the road angle ϕ_{R}, the calculated quantity ϕ_{VR} Increases by 3 percent, for example, as the vehicle rocks backward relative to the ground. The measured quantity ϕ_{V} is 0 percent relative to gravity during acceleration because the backwards rocking movement of the vehicle offsets the effect of the grade decline during acceleration. ϕ_{R}, the calculated road angle, is equal to about −3 percent according to the above equation, thereby indicating a grade decline.
ϕ_{VR}=+3%
ϕ_{V}=0%
ϕ_{R}=ϕ_{V}−ϕ_{VR}=0%−(+3%)=−3%

FIG. 2F depicts a schematic view of deceleration of a vehicle on a grade decline. In accordance with the exemplary equations shown below for discounting deceleration from the road angle ϕ_{R}, the calculated quantity ϕ_{VR} decreases by 3 percent, for example, as the vehicle rocks forward relative to the ground due to the deceleration. The measured quantity ϕ_{V} decreases by 6 percent because the forward rocking movement of the vehicle is compounded by the grade decline during deceleration. ϕ_{R}, the calculated road angle, is equal to about −3 percent according to the above equation, thereby indicating a grade decline. It is noted that ϕ_{R}, the calculated road angle, shown in FIG. 2F is equal to that of FIG. 2E regardless of the maneuvers of the vehicle.
ϕ_{VR}=−3%
ϕ_{V}=−6%
ϕ_{R}=ϕ_{V}−ϕ_{VR}=−6%−(−3%)=−3%

For each of the maneuvers of the vehicle described above, software is used to calculate grade in real time. The road grade is typically calculated and stored as a percentage, as illustrated above.

The road grade information can be used for various purposes. By way of non-limiting example, the road grade information may be (i) displayed to a driver of the vehicle in real time, (ii) uploaded and stored in a GPS program for various purposes (such as to plot a vehicle route having a high fuel economy), or (iii) applied to the vehicle by a dynamometer 120 in a virtual test of the vehicle 100 in a laboratory setting.

More particularly, according to one aspect of the invention, a method for measuring a grade of a road using the system 400 includes the steps of: moving the vehicle 100 over a path and calculating, storing, and associating the plurality of road grades with the geolocations along the path.

A method for providing navigational information for a vehicle includes the steps of measuring the grade of a road associated with geolocations of the road, and associating the grade of the road with other road information corresponding to the same geolocations and storing the associations in a navigational database. The grade of the road is then provided to a user of the navigational database.

The systems and methods described above may also be used for laboratory testing of a vehicle. According to one aspect of the invention, a system for testing the vehicle 100 in a laboratory comprises a dynamometer 120 connected to the vehicle 100 to be tested. A user input 122 is provided for selecting a virtual path for testing the vehicle by simulated driving of the vehicle along the virtual path, wherein the virtual path corresponds to an existing physical path. A processor 124 is configured to access navigational information, from the above-described navigational database, comprising road grade Information associated with geolocations along the physical path corresponding to the virtual path and to move the dynamometer 120 in accordance with the road grade information during the simulated driving of the vehicle 100 along the virtual path. The user input 122 and the processor 124 may be integrated with or separate from the dynamometer 120.

A method for testing the vehicle 100 includes selecting a virtual path (by a user) for testing of a vehicle 100 by simulated driving of the vehicle along a virtual path; providing the navigational information corresponding to the virtual path, the navigational information comprising road grade information associated with geolocations along the virtual path; and moving the dynamometer 120 connected to the vehicle 100 in accordance with the road grade information in the navigational database during the simulated driving of the vehicle. The road grade information associated with the geolocations is provided in accordance with the above described method for providing navigational information for a vehicle.

Although described herein in connection with certain examples and exemplary sensor types, the invention is not limited to the specific sensors or other components, examples, or embodiments discussed herein. Likewise, although illustrated with exemplary calculations for processing exemplary information collected by the system, systems in accordance with the invention are not limited to specific calculations or the collection of specific data. Accordingly, exemplary embodiments of the system may comprise fewer or more components and may have lesser or more function than the examples described herein.

In addition to the systems and methods described herein for collecting road grade data, including systems comprising components configured for installation on a vehicle and vehicles equipped with such components, aspects of the invention may further comprise methods of providing navigational information derived pursuant to the methods described herein, including supplying the derived information to a user of the navigational information, methods of testing a car using such navigational information, and methods of driving using such information. Additionally, aspects of the invention include computer readable media programmed with instructions, including computer hardware having computer software installed thereon, for determining road grade information as described herein, including instructions for carrying out the processing and calculations as described herein, for receiving and storing the road grade data, for serving road grade data to users of navigational information, and for receiving and displaying road grade information to a user. Thus, aspects of the invention include on board navigational systems programmed with such instructions. In some embodiments, such as mobile applications embodying the programming associated with displaying such information, certain programmed instructions may reside on a computer server accessible from a global computer information network and other instructions may reside on a handheld device in communication with the computer server. Data storage associated with any of the aspects of the invention may be locally stored on computer readable media or stored on servers accessible via a global computer network.

1. A system for calculating a grade of a road, the system comprising:
at least two ride height sensors, each sensor configured for mounting to a first vehicle in a mounting location and configured to detect a distance between the road and the mounting location;
one or more acceleration sensors configured for mounting to the first vehicle, each sensor configured to detect acceleration of the first vehicle along at least one axis;
one or more gyroscopes configured for mounting to the first vehicle, each gyroscope configured to detect one of pitch, roll or yaw of the first vehicle;
a global positioning unit configured for mounting to the first vehicle, the global positioning unit configured to determine a geolocation of the first vehicle;
a processor having a plurality of inputs, including at least one input configured to be connected to a data output from each of the at least two ride height sensors, at least one input configured to be connected to the one or more acceleration sensors, at least one input configured to be connected to the one or more gyroscopes, and at least one input configured to be connected to the global positioning unit, the processor configured to calculate road grade from the plurality of inputs and to associate the calculated road grade with geolocation of the first vehicle associated with the calculated road grade; and
a computer memory configured to be connected to the processor and to receive and store the calculated road grade and associated geolocation in a computer readable memory for a plurality of geolocations along a path of the first vehicle.

2. The system of claim 1, wherein one of the at least two ride height sensors is located relatively closer to a front of the first vehicle and another of the at least two ride height sensors is located relatively closer to a rear of the first vehicle.

3. The system of claim 2, wherein the at least two ride height sensors are each positioned on a centerline of the first vehicle on a longitudinal plane parallel to the road.

4. The system of claim 1, wherein the one or more acceleration sensors comprise a first acceleration sensor configured to measure acceleration in an X direction, a second acceleration sensor configured to measure acceleration in a Y direction perpendicular to the X direction, and a third acceleration sensor configured to measure acceleration in a Z direction perpendicular to the X and the Y directions.

5. The system of claim 1, wherein the one or more gyroscopes comprise a first gyroscope configured to detect pitch of the first vehicle, a second gyroscope configured to detect roll of the first vehicle, and a third gyroscope configured to detect yaw of the first vehicle.

6. The system of claim 1, wherein the one or more acceleration sensors and the one or more gyroscopes are integrated into an inertial measuring unit.

7. The system claim 1, further comprising a data collection unit connected to the at least two ride height sensors, the one or more acceleration sensors, the one or more gyroscopes, and the global positioning unit, the data collection unit configured to collect data comprising one or more of time, velocity, heading, height, vertical velocity, lateral acceleration, longitudinal acceleration, radius of turn, centerline deviation, pitch angle, roll angle, and yaw angle.

8. The system of claim 1, wherein the processor is configured to calculate the road grade in real time.

9. The system of claim 1, comprising the first vehicle having the at least two ride height sensors, the one or more acceleration sensors, the one or more gyroscopes and the global positioning unit mounted to the first vehicle, and the at least two ride height sensors, the one or more acceleration sensors, the one or more gyroscopes, the global positioning unit and the computer memory connected to the processor.

10. A method for measuring a grade of a road, the method comprising the steps of:
providing the system of claim 9;
moving the first vehicle over the path and calculating, storing, and associating the plurality of road grades with the geolocations along the path.

11. A process for compiling navigational information, the process comprising:
measuring the grade of a road associated with geolocations of the road in accordance with the method of claim 10; and
associating the grade of the road with other road information corresponding to the same geolocations and storing the associations in a navigational database as stored navigational information in a computer memory.

12. A method for obtaining navigation information, the method comprising receiving navigational information including road grade information from the navigational database product of claim 23.

13. The method of claim 12, comprising testing a second vehicle, the method comprising:
providing the second vehicle;
providing a dynamometer configured to receive the second vehicle, and mounting the second vehicle on the dynamometer;
selecting a virtual path for testing of the second vehicle;
simulating driving of the vehicle along the virtual path by providing navigational information corresponding to the virtual path from the navigational database product including the road grade information associated with geolocations along the virtual path; and
moving the dynamometer in accordance with the road grade information in the navigational database during the simulated driving of the vehicle.

14. (canceled)

15. A navigational device comprising:
an input for receiving a geolocation command; and
a processor configured for communication with the navigational database product of claim 23, the processor configured to retrieve the stored navigational information from the navigational database product, including road grade information stored in the database.

16. The device of claim 15 further comprising an output configured to display the road grade information.

17. The device of claim 15, wherein the processor is further configured to recommend a path between two or more geolocation points entered by a user in accordance with recommendation criteria, wherein the recommendation criteria includes said road grade information.

18. The device of claim 15, wherein the input for receiving the geolocation command includes a receiver configured to receive geolocation information corresponding to a position of the device.

19. The device of claim 18, wherein the input for receiving the geolocation command includes a user input for specifying the at least two geolocation points.

20. The device of claim 15, wherein the device comprises the navigational database product integrated into a local computer memory of the device.

21. The device of claim 15, further comprising a transceiver configured to transmit and receive information from a global computer information network, wherein the navigational database product is connected to the global computer information network and not integrated into the device.

22. A system for testing a vehicle, the system comprising:
a dynamometer configured to receive the vehicle to be tested;
a user input for selecting a virtual path for testing the vehicle by simulated driving of the vehicle along the virtual path, the virtual path corresponding to an existing physical path; and
a processor configured to access navigational information from the navigational database product of claim 23, the navigational information comprising road grade information associated with geolocations along the physical path corresponding to the virtual path and to move the dynamometer in accordance with the road grade information during the simulated driving of the vehicle along the virtual path.

23. A navigational database product comprising a computer memory populated with stored navigational information compiled by the process of claim 11.
